(19) United States
(12) Patent Application Publication
(10) Pub. No.: US 2007/0039448 A1
(43) Pub. Date: Feb. 22, 2007

(54) Expression centered singing

(76) Inventor: Shelly Franklin Rose, Los Gatos, CA (US)

Correspondence Address: Neville Law Group, PO Box 61063, Palo Alto, CA, 94036, US

(21) Appl. No.: 11/507,396

(22) Filed: Aug. 21, 2006

Related U.S. Application Data
(60) Provisional application No. 60/710,024, filed on Aug. 22, 2005.

(51) Int. Cl. G09B 15/00; G09B 15/04; G09B 15/02

(52) U.S. Cl. 84/470 R

(57) ABSTRACT

The invention provides a method of teaching singing calculated to optimize the singer's natural, intuitive capability to emote sound associated with a “feeling” and thereby to experience consciously (“tag”) the physical positions of the sound producing musculature within the singer's body. The method provides a means for the teacher of singing to bypass technical or mechanical exercises and holistically and organically tap the singer's natural muscle coordination associated with “emotive” sounds. The method further provides a tool for achieving muscle coordination throughout the singer's entire range, including bridge regions.

### RELATED APPLICATIONS

This application is related to and claims priority from U.S. Provisional Application No. 60/710,024 by the same inventor, said application which is incorporated in its entirety as if fully set forth herein.

### GOVERNMENT FUNDING

Not Applicable.

### BACKGROUND

Commonly used methods of teaching singing to humans involve the teaching of mechanical methods of leading the vocal chords into specific positions for the desired sound output.

Students of singing are often characterized by the range of their voice, which in large part is a function of the singer's vocal chords. In the absence of injury, an otherwise functional set of vocal chords will be able to move in a desired manner to produce sound in the range of the singer (e.g. soprano, tenor, alto or bass).

In mastering a consistent singing voice throughout the range, it is often challenging to master “bridges” or passage areas. These bridges are associated with musculature positioning that may be resistant to the students ability to master despite conscientious and motivated application of conventional mechanical singing exercises.

In many instances, the student may be hindered from being able to achieve the mechanical position volitionally in response to conventional instruction, although physically capable of creating the sound the teacher is attempting to evoke.

Until the singer becomes aware of the desired position(s) as experienced within his or her own physical self, it is difficult to either benefit from otherwise effective teaching techniques, or to produce the sounds in a governable manner. Teachers of singing may also be hindered, through language or cultural barriers with various students (whose first language may be different form that of the instructor's, for example) from being able to coach the student.

What is needed is a method of teaching singing that uses the singer's natural capability to produce human sounds as a precursor to singing. What is also needed is method for facilitating association of the singer's individual emotive sound production with a learned sound production.

### BRIEF DESCRIPTION OF THE INVENTION

The invention taught herein provides satisfaction of at least each of the articulated and/or unmet needs set forth hereinabove. The invention, which may be referred to as “Expression Centered Singing” or “ECS” is not intended to be limited to the commonly understood meaning of “singing” but rather is intended to include any vocalization which involves the vocal chords in whole or in part. The invention provides a method of accessing desired muscle coordination by means of evoking individual expression associated with emotive sound. Emotive sounds, as used herein, includes an individual's sound produced as an accompaniment to un-self-conscious emotional expression, and naturally coordinate complex muscle function. The human baby typically emotes—cries—shortly after birth. As sound production in the human occurs well before language (words), the individual may, through the use of this intuitive-accessing pre-language approach, tap his or her natural musculature, circumventing the language functions.

The steps of the preferred embodiment of the method comprise:

instructing student to produce a first emotive vocalization;

determining, upon registering student responsive first emotive vocalization, whether said responsive first emotive vocalization has desired sonic characteristics;

repeating instructing student to produce a first emotive vocalization until desired sonic characteristics are attained, and

directing student to “tag” the physical sensation associated with producing the desired sonic characteristics so as to enable student to re-create desired sonic characteristics.

The student is guided by the teacher to vocalize emotion, using tools (“triggers”) such as:
a) the communication of “no”;
b) wordless sounds as may accompany anger;
c) wordless sounds as may accompany weeping;
d) wordless sounds as may accompany panic, frustration, dissatisfaction or agitation;
e) wordless sounds as may accompany agony, fear, grief or loss (moaning);
f) wordless sounds as may accompany any other “trigger” emotion.
   As a further “tagging” of the physical sensations experienced during the emotive vocalizations, the teacher may then guide the student through word-like of word sound series in a range of pitches suitable to the student's range.

The method further provides a series of coaching tools designed to achieve desired muscle coordination, and in particular coordination in the singer's “bridge” or passage areas.

The invention provides a tool for overcoming language barriers between teacher and student, may be used with very young students and may also be used in vocalization acquisition or re-acquisition as a part of, for example, post-injury rehabilitation or as a component of physical, cognitive or emotional therapy.

### BRIEF DESCRIPTION OF THE DRAWINGS

FIG. 1 illustrates the method as applied during a hypothetical lesson according to the invention.

### DETAILED DESCRIPTION OF THE PREFERRED EMBODIMENT

It is to be understood that the use of any form of the terms “sing” or “singer” are intended to mean “vocalize” or “vocalizer”. Depending on the application of the method, the vocalizer may be a student, subject or patient, and the use of any term is intended to include any alternate term used herein. The term “instruct” or “instructing” means any communication, verbal or non-verbal, calculated to evoke the desired emotive vocalization.

Further, insofar as the invention may be applied to singers of every range, it is to be understood that many of the aspects of the method are described in broadest strokes, yet can be appreciated and understood by those of skill in the relevant art. Further, it is to be understood that the examples used herein are illustrative, and not intended to be limitations on the invention.

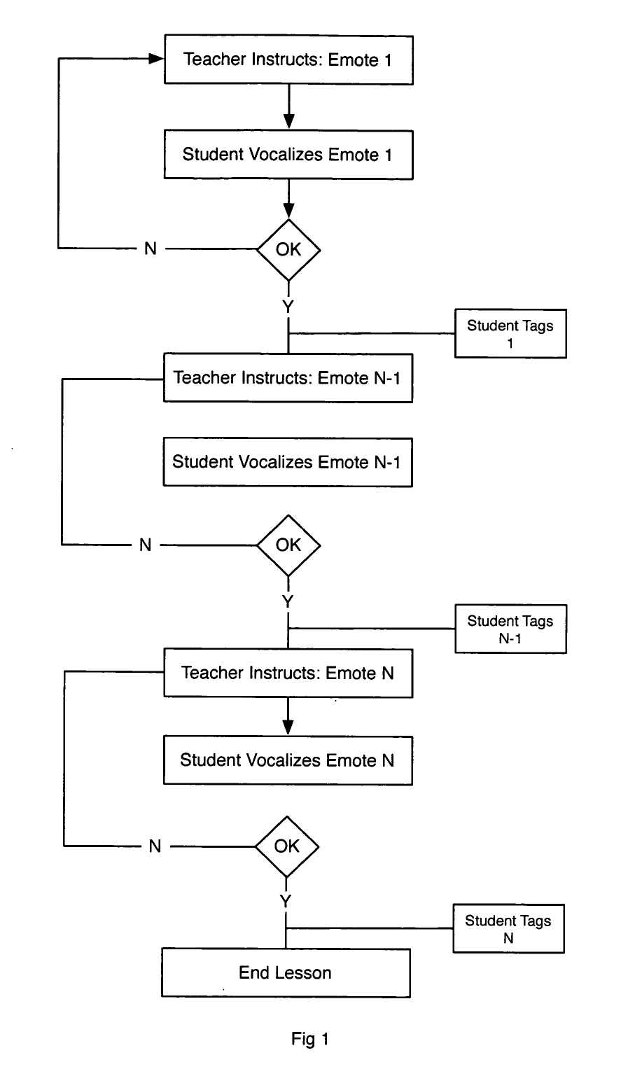

Referring to FIG. 1, the inventive method for teaching singing comprises the steps of:

instructing student to produce a first emotive vocalization;

determining, upon registering student responsive first emotive vocalization, whether said responsive first emotive vocalization has desired sonic characteristics;

repeating instructing student to produce a first emotive vocalization until desired sonic characteristics are attained, and

directing student to tag the physical sensation associated with producing the desired sonic characteristics so as to enable student to re-produce said desired sonic characteristics.

Repetition of any given emotive vocalization is at the discretion of the teacher, although it has been empirically determined that the method is particularly effective when a variety of emotive vocalizations are used. Moreover, fewer repetitions (as few as two or three) are helpful in cases where the desired sonic characteristics are not achieved, contrary to some approaches where repetition is persisted despite inability of the student to achieve the desired vocalization.

The method provides the step of instructing the student to produce a plurality of emotive vocalizations, using at least one of a collection of tools calculated to trigger or assist emotive vocalization, said collection including:
a) vocalizing the communication of “no”;
b) vocalizing wordless sounds as may accompany anger;
c) vocalizing wordless sounds as may accompany weeping;
d) vocalizing wordless sounds as may accompany panic or agitation
e) vocalizing wordless sounds as may accompany agony, fear, grief or loss (moaning); and
f) vocalizing wordless sounds as may accompany any other “trigger” emotion.

A “trigger” emotion, as used herein, includes any emotion which for any individual, allows the individual to intuitively or reflexively organize his or her vocalization musculature so as to produce a desired sound.

The inventive method further includes the step of “tagging” the physical sensations experienced during an emotive vocalization, and guiding the student through word-like or word sound series in a range of pitches suitable to the student's vocal range.

The method further includes the step of guiding the student through word-like or word sound series in a variety of volumes.

Where optimization of singing performance is a goal, the instructions may be tailored and calculated to optimize sound production throughout the student's entire vocal range, including what are commonly understood to be one or more “bridges”. For example, having the student emotively vocalize a negative, such as a word or word-like sound (e.g. the communication of “no”), where the emotive expression may be anger or panic, frequently provides a direct and efficient access to the singer's so-called “chest voice”.

Regardless of the skill set of any singer, the method enhances natural expression throughout the singer's entire range. For example, to move through a “bridge”—a critical passage area for many singers, the teacher may instruct the student to invoke an “expressive sound” communicating “edginess”, pique, weepiness, or other emotional agitation. The instruction to produce emotive vocalizations creates for the singer a simple, holistic and intuitive template enabling the individual's vocal chords to naturally and effortlessly attain the desired position to produce the desired sound.

Further, the method provides a tool useful in producing sound generally, whether or not associated with a bridge. The instruction to “moan” and subsequently to tag the physical sensations experienced during the sound production enhances a singer's overall ability to vocalize in a singing fashion across a variety of vocal ranges.

Insomuch as the method provides a means for the teacher of singing to bypass technical or mechanical exercises and holistically and organically tap the singer's natural muscle coordination associated with “emotive” sounds, the invention also provides a tool for overcoming language barriers between teacher and student, may be used with very young students and may also be used in post-injury rehabilitation or therapy.

The step of instructing may, for example, be accomplished with non-verbal cueing in any effective mode or combination of modes, including but not limited to imitation of the teacher, visual or auditory cues calculated to effect emotion triggering, or physical posturing.

Broadly speaking the inventive method may be applied to any manner of eliciting human sound patterning.

An alternate embodiment of the method provides for the patterning human sound production, said method comprising:

instructing subject to produce a first emotive vocalization;

determining, upon registering subject's responsive first emotive vocalization, whether said responsive first emotive vocalization has desired sonic characteristics;

repeating instructing subject to produce a first emotive vocalization until desired sonic characteristics are attained, and

directing subject to tag the physical sensation associated with producing the desired sonic characteristics so as to enable subject to re-produce said desired sonic characteristics.

The method further includes the step of instructing the subject to produce a plurality of emotive vocalizations, using at least one of a collection of tools calculated to trigger or assist emotive vocalization, said collection including:
a) vocalizing the communication of “no”;
b) vocalizing wordless sounds as may accompany anger;
c) vocalizing wordless sounds as may accompany weeping;
d) vocalizing wordless sounds as may accompany panic or agitation
e) vocalizing wordless sounds as may accompany agony, fear, grief or loss (moaning); and
f) vocalizing wordless sounds as may accompany any other “trigger” emotion.

At any point, the instructor/teacher facilitates the “tagging” of the physical sensations experienced by the student, subject or patient during an emotive vocalization. Further, as a function of the objective for any individual, the method provides for guiding the student, subject or patient through word-like or word sound series in a range of pitches suitable to the subjects vocal range.

In addition to pitch variations and combinations, the method further includes the step of guiding the subject through word-like or word sound series in a variety of volumes.

Any combination of pitches and volumes may also be used to emote in a series useful to govern the entire range of which the singer. subject or patient is potentially capable.

As can be appreciated, the invention may be applied not only to the healthy student of any age, but also to the very young, to injured singers (for example, injury resulting from some physical or mental trauma) or singers with whom a more technical manner of instruction is difficult owing to language expression/comprehension barriers.

Moreover, as singing and vocalization may be useful to the treatment of speech impediments, as well as to overcoming emotional imbalances, mood disorders or conditions (e.g. depression, including morbid depression with or without catatonia), the inventive tool has application in situations where the goal is other than performance. Therapeutic or rehabilitative settings, including but not limited to treatment of post-stroke or cerebral trauma, or delayed or impaired language acquisition, are also within the scope of contemplated applications of the invention taught herein.

The embodiments set forth herein are merely illustrative of the principles and applications of the present invention. Numerous modifications may be made to the illustrative embodiments and other arrangements may be devised within the scope of the present invention as taught by the specification, the drawings, and any appended claims.

We claim:

1. A method for teaching singing comprising:
instructing student to produce a first emotive vocalization;
determining, upon registering student responsive first emotive vocalization, whether said responsive first emotive vocalization has desired sonic characteristics;
repeating instructing student to produce a first emotive vocalization until desired sonic characteristics are attained, and
directing student to tag the physical sensation associated with producing the desired sonic characteristics so as to enable student to re-produce said desired sonic characteristics.

2. The method of claim 1 further including the step of instructing the student to produce a plurality of emotive vocalizations, using at least one of a collection of tools calculated to trigger or assist emotive vocalization, said collection including:
a) vocalizing the communication of “no”;
b) vocalizing wordless sounds as may accompany anger;
c) vocalizing wordless sounds as may accompany weeping;
d) vocalizing wordless sounds as may accompany panic or agitation;
e) vocalizing wordless sounds as may accompany agony, fear, grief or loss (moaning); and
f) vocalizing wordless sounds as may accompany any other “trigger” emotion.

3. The method of claim 2 further including the step of, after “tagging” the physical sensations experienced during an emotive vocalization, guiding the student through word-like or word sound series in a range of pitches suitable to the student's vocal range.

4. The method of claim 3 further including the step of guiding the student through word-like or word sound series in a variety of volumes.

5. The method of claim 4 wherein the instructions are calculated to optimize sound production throughout the student's entire vocal range, including one or more bridges.

6. A method for patterning human sound production, said method comprising:
instructing subject to produce a first emotive vocalization;
determining, upon registering subject's responsive first emotive vocalization, whether said responsive first emotive vocalization has desired sonic characteristics;
repeating instructing subject to produce a first emotive vocalization until desired sonic characteristics are attained, and
directing subject to tag the physical sensation associated with producing the desired sonic characteristics so as to enable subject to re-produce said desired sonic characteristics.

7. The method of claim 6 further including the step of instructing the subject to produce a plurality of emotive vocalizations, using at least one of a collection of tools calculated to trigger or assist emotive vocalization, said collection including:
a) vocalizing the communication of “no”;
b) vocalizing wordless sounds as may accompany anger;
c) vocalizing wordless sounds as may accompany weeping;
d) vocalizing wordless sounds as may accompany panic or agitation
e) vocalizing wordless sounds as may accompany agony, fear, grief or loss (moaning); and
f) vocalizing wordless sounds as may accompany any other “trigger” emotion.

8. The method of claim 7 further including the step of, after “tagging” the physical sensations experienced during an emotive vocalization, guiding the subject through word-like or word sound series in a range of pitches suitable to the subjects vocal range.

9. The method of claim 8 further including the step of guiding the subject through word-like or word sound series in a variety of volumes.
